(19) United States
(12) Patent Application Publication
(10) Pub. No.: US 2024/0137632 A1
(43) Pub. Date: Apr. 25, 2024

(54) ENGINEERED POINT SPREAD FUNCTION (ePSF) OBJECTIVE LENSES

(71) Applicant: Double Helix Optics Inc., Boulder, CO (US)

(72) Inventors: Anurag Agrawal, Ft. Collins, CO (US); Warren Colomb, Arvada, CO (US); Scott Gaumer, Greenbrae, CA (US); Rafael Piestun, Boulder, CO (US)

(21) Appl. No.: 18/489,648

(22) Filed: Oct. 18, 2023

Related U.S. Application Data
(60) Provisional application No. 63/380,056, filed on Oct. 18, 2022.

(51) Int. Cl. H04N 23/55; G02B 27/09

(52) U.S. Cl. CPC H04N 23/55; G02B 27/0988

(57) ABSTRACT

In an example embodiment an objective lens includes one or more lenses, an outer housing, and a mask. The outer housing is configured to encompass at least the one or more lenses. The mask is to shape a point spread function (PSF) of the objective lens to define an engineered PSF (ePSF) of the objective lens. In another example embodiment, a method includes directing light from a scene through an optical system that includes the objective lens. The optical system generates the PSF that varies based on depth within the scene. The method includes generating, using a light detector, an image of the scene from the light that passes through the optical system. The method includes estimating a property of one or more objects within the scene from the image of the scene.

### CROSS-REFERENCE TO RELATED APPLICATION

This application claims the benefit of and priority to U.S. Provisional App. No. 63/380,056, filed on Oct. 18, 2022. The 63/380,056 application is herein incorporated by reference.

### FIELD

The embodiments discussed in the present disclosure are related to engineering a point spread function of an optical system.

### BACKGROUND

Unless otherwise indicated herein, the materials described herein are not prior art to the claims in the present application and are not admitted to be prior art by inclusion in this section.

Objective lenses are optical components configured to gather light emerging from an observed object and to direct the gathered light toward an ocular lens for imaging and can also be used for illumination to direct light onto an object. The quality and design of objective lenses significantly affects image quality, resolution, and overall performance of optical systems in which the objective lenses are used. Objective lenses are ubiquitous optical components used in a wide variety of applications in life sciences, pharma, measurement and ranging, machine vision, and industrial inspection.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, an objective lens includes one or more lenses, an outer housing, and a mask. The outer housing is configured to encompass at least the one or more lenses. The shapes a point spread function (PSF) of the objective lens to define an engineered PSF (ePSF) of the objective lens.

In another example embodiment, a computational imaging system includes, a light source, an optical system, an objective lens, a detector, and a computing device. The optical system is configured to illuminate a scene or a sample with light from the light source and to direct light from the scene or the sample to the detector. The objective lens is included in the optical system, the objective lens including a mask to shape a three-dimensional (3D) PSF of the optical system to define an ePSF of the optical system. The detector is configured to receive light from the scene or the sample after it passes through the objective lens and to generate an image from the received light. The computing device is communicatively coupled to the light detector, the computing device configured to estimate properties of one or more objects within the scene or the sample from the image.

In another example embodiment, a method includes directing light from a scene through an optical system that includes an objective lens containing a mask. The optical system generates a PSF that varies based on depth within the scene. The method includes generating, using a light detector, an image of the scene from the light that passes through the optical system. The method includes estimating a property of one or more objects within the scene from the image of the scene.

Additional features and advantages of these embodiments will be set forth in the description which follows, and in part will be obvious from the description, or may be learned by the practice of the embodiments. The features and advantages of these embodiments may be realized and obtained by means of the instruments and combinations particularly pointed out in the appended claims. These and other features of the present embodiments will become more fully apparent from the following description and appended claims or may be learned by the practice of the embodiments as set forth hereinafter.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1A illustrates an example optical system;

FIG. 1B illustrates another example optical system;

FIGS. 2A-2D illustrate various example objective lenses that may be implemented in the optical systems of FIGS. 1A-1B;

FIGS. 3A-3G illustrate some example masks that may be implemented in an optical element that may be placed with an objective lens of an optical system to modify PSF;

FIGS. 4A-4B illustrate graphical representations of simulations of various axially varying PSFs such as may be implemented in an optical system, such as the optical system of FIG. 1A;

FIG. 5A illustrates graphical representations of simulations of PSFs such as may be implemented in an optical system, such as the optical system of FIG. 1A;

FIG. 5B illustrates a phase mask of an example optical element used for some of the simulations of FIG. 5A and includes a circularly symmetric pattern that maintains circular symmetry of a DF PSF relative to a standard PSF;

FIG. 6 illustrates an infinity-corrected optical system that includes an objective lens and a tube lens together with a corresponding ray tracing simulation;

FIG. 7 illustrates synthetic images of a US Air Force (USAF) 1951 target;

FIG. 8 illustrates recovered images generated by applying a computational recovery algorithm to the synthetic images of FIG. 7;

FIG. 9 illustrates images of a 3D distribution of fluorescent beads in agarose;

FIG. 10 includes images that illustrate the effect of an objective lens with an OT DF ePSF on a 3D fluorescent object;

FIG. 11 includes experimental data comparing unmodified and extended depth of field ePSF objective lenses for high throughput imaging of genomic loci in fixed cells to investigate mRNA mechanisms;

FIG. 12 includes experimental data comparing unmodified and extended depth of field ePSF objective lenses for use in Ca+ signaling in bone;

FIG. 13 illustrates a flow chart of an example method of applying a computational recovery algorithm to an image;

FIG. 14 illustrates a flow chart of an example method of optimizing an objective lens; and

FIG. 15 illustrates a block diagram of an example computing system,

all arranged in accordance with at least one embodiment described herein.

### DETAILED DESCRIPTION

In the following detailed description, reference is made to the accompanying drawings, which form a part hereof. The illustrative embodiments described in the detailed description, drawings and claims are not meant to be limiting. Other embodiments may be utilized, and other changes may be made without departing form the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Most objective lenses are designed in accordance with Gaussian optics design principles. These objective lenses may be designed to operate using a highest possible resolution and highest image quality only at a nominal focal plane. If the sample's axial dimension is greater than (e.g., extends outside) the depth of field (the axial range over which a scene appears to be “in focus”) associated with this nominal focal plane, the data and/or images that are obtained of the sample may include errors (e.g., may be out of focus or incomplete). As a result, objective lens design is affected by intrinsic tradeoffs. For example, objective lenses with a higher numerical aperture (NA) may have greater resolution and lower depth of field. On the other hand, objective lenses with a lower NA may have lower resolution and greater depth of field. Objective lenses designed in accordance with Gaussian optics design principles may be unable to simultaneously provide both high image resolution and large depth of field.

Generally, optical systems are built around lenses designed for best performance at focus. With emphasis on focus, objective lenses are often configured to produce a diffraction-limited image at a single focal plane. Optimization at a single focal plane limits out-of-plane performance of the optical systems.

One application of interest is sample analysis, e.g., for successful assays or diagnostics. Capturing sufficient data to assess a sample's composition determines overall screen quality. For example, a volume of the sample captures may be a factor in efficiently collecting high-quality sample information, as out-of-focus data may irretrievably be lost. An approach to improve the depth of field may involve increasing capture volume through use of axial scanning. Some optical systems that include the objective lenses may perform axial scanning to generate a combined image of a sample that is greater than the depth of field. Axial scanning may involve stepping through focus of the objective lens (e.g., stepping through focus in a z axis away or towards the objective lens) and capturing images of different portions of the sample at each axial step. A computing device may stitch each image together in post processing to generate the combined image. However, the axial scanning may lead to issues with increased phototoxicity, photobleaching, acquisition time, and dataset size. In some embodiments herein, however, ePSF objective lenses enable extended depth of field, thereby allowing for the capture of a larger sample volume in each image, thus reducing or eliminating the need for axial scanning by providing more information in each image than with unmodified objective lenses.

According to some embodiments herein, the depth of field of an optical system and/or objective lens may be improved by modifying a point spread function (PSF) of the optical system. The PSF of the optical system may be engineered to allow the optical system to maintain a higher degree of lateral and axial resolution while extending the depth of field. For example, the PSF may be engineered by modifying phase, amplitude, spectral response, polarization or some combination thereof. As an example, the PSF of an optical system may be engineered by including an optical element with a spatially varying phase function (or other function) at a specific location within the optical system, such as at or near the back aperture, the back focal plane, the pupil plane, or other location within the optical system, the phase function serving to modify the optical system's PSF. In this example, the PSF may be modified to maintain a high degree of invariance with axial depth which may effectively extend the depth of field. The example depth-invariant ePSF may be combined with one or more reconstruction algorithms to image objects over a greater depth of field and with a lateral resolution comparable to, or better than, the resolution of the unmodified optical system. Alternatively, the PSF can be modified to create a high degree of variance with axial depth, effectively encoding axial position into the shape of the PSF over the depth of field, which can simultaneously be extended as compared to the unmodified optical system. When combined with reconstruction algorithms, it is possible, for example, to use such a strongly depth-variant PSF to capture 3D information from a single 2D image.

Unfortunately, current approaches for PSF engineering require large and extended systems composed of multiple lenses and other optical elements. Further, such approaches may not be applicable to objective lenses that require special considerations for integration in a single package with a compact form factor.

Generally, the present disclosure relates to an optical system with an ePSF and/or to modifying the PSF of an optical system to maintain a high degree of lateral and axial resolution while extending a depth of field of the optical system. Embodiments herein may have application in the fields of industrial inspection, biological imaging, ranging, sensing, and coordinate measurement where a high degree of accuracy needs to be achieved over a great axial distance. Some specific applications may include measuring components on a printed circuit board, inspecting dental implants, imaging mRNA in a tissue section, tooling inspection, or computer vision.

In some embodiments, the PSF may be modified or engineered through modification or integration within an objective lens of the optical system of one or more optical elements. For example, the optical elements may be placed between, behind, or in front of different lenses of the objective lens. The optical elements may be configured to spatially modulate amplitude, phase, spectral response, or polarization of optical field to engineer one or more PSF characteristics. The optical elements may be or include masks configured to modify the one or more PSF characteristics. In some embodiments, the optical elements may include masks with ePSF performance optimized in conjunction with an optical model of the objective lens and/or a modulating mask integrated with or within the objective lens. In some embodiments, the masks may be designed for one or more of a specific wavelength, a specific range of wavelengths, a polarization state, and/or to shape the space-invariant polarization of the PSF. In some embodiments, the objective lens may be designed to generate a desired ePSF without need for additional phase elements or masks, to optimize the objective lens PSF in 3D, and/or to compensate for aberrations in 3D or on more than one transverse plane. In some embodiments, the masks may be placed in a Fourier plane, on a pupil plane, in an image plane, or in another suitable plane relative to the lenses of the objective lens. Alternatively or additionally, the masks may generate a set of at least two spots located in 3D space to represent a given imaged object.

The methods, devices, and/or systems described herein may take into account various factors such as the shape of the PSF, depth of field, Fisher Information, Cramér-Rao Bound, Mutual information, etc. as optimization parameters in the implementation of ePSF objective lenses for 3D performance, as opposed to a single focal plane. For example, these objective lenses may make use of a dielectric mask, or pattern, placed directly at the pupil plane of the objective lenses.

In some embodiments, the optical system with ePSF may be optimized for desired performance without modification for integration into existing optical systems. For example, the one or more masks may be placed within the objective lens (without changing the shape of the objective lens or with minimal changes to the shape of the objective lens) to allow placement of the objective lens in the optical system with little or no modifications to the optical system.

In some embodiments, design of the mask to be integrated with the objective lens may include a 3D optical response/propagation model. In some embodiments, the 3D optical model may include electromagnetic components suitable to respond to different polarization states or other parameters of the optical system. In some embodiments, the 3D optical model may describe nanoscale interaction of light with a specific mask structure. In some embodiments, the 3D optical model may include resonant structures integrated within the objective lens.

In some embodiments, one or more components of the objective lens may be designed to accommodate or complement functions of one or more masks. For example, an amplitude mask, a nonlinear amplitude mask, a pupil-modifying mask, and/or an apodization mask may be combined with the objective lens in addition to one or more other masks to produce an ePSF objective lens with a given 3D optical response.

In some embodiments, a response of the objective lens may be dependent on the polarization state of light. The objective lens may include space-variant polarization elements. For example, the objective lens may include Pancharatnam-Berry phase modulation, pixelated elements with micro polarizers, liquid crystal devices, pixelated anisotropic elements, optical elements with stress-induced anisotropy, metamaterials, other space-variant polarization elements, or any combination thereof.

In some embodiments, the objective lens may include a grating. For example, the objective lens may include a periodic structure configured to generate a 3D PSF that may vary in 3D space, encoding 3D and/or a polarization information. In these and other embodiments, the grating may be located between, behind, or in front of different lenses of the objective lens.

One or more embodiments described in the present disclosure may enhance extended depth of field generated by ePSF objective lenses through computational recovery algorithms. In some embodiments, extending the depth of field via an ePSF naturally leads to a redistribution of available photons over a larger focal volume due to conservation of energy. In some embodiments, the redistribution may cause lower peak signals and reduced signal-to-noise ratio (SNR) that may be proportional to the depth of field extension. In these and other embodiments, the computational recovery algorithms may be implemented to improve the SNR, e.g., using reconstruction or restoration algorithms. In some embodiments, the computational recovery algorithms may include deblurring, deconvolution, and/or other algorithms. The computational recovery algorithms may deblur and restore 2D or 3D image resolution. In some embodiments, the computational recovery algorithms may include an algorithm based on a Richardson-Lucy approach. In these and other embodiments, such computational recovery algorithms (e.g., post processing, reconstruction or image restoration algorithms) applied to the resulting images may be matched to corresponding specific ePSF objective lens designs, enabling, for instance, improvement in imaging speed or resolution in three dimensions. Deconvolution is one example of a process to spatially restore an emission source (or sources) from blurred image data and may best be done with a priori knowledge of the ePSF of a corresponding optical system. A 3D PSF shape of such an ePSF may be such that maximum physical information is represented, a property quantified through the Optical Transfer Function (OTF). In some embodiments, such deconvolution processes and/or other recovery algorithms can optimally restore signal from ePSF objective lenses using a priori knowledge of the ePSF optimized in conjunction with the objective lens.

In some embodiments, ePSF objective lenses may be designed to be robust to optical path misalignments and aberrations, adaptable to perturbations in magnification/numerical aperture, and to integrate into existing instrumentation (e.g., existing optical systems). In some embodiments, ePSFs with intensity describing a curve, or curves, in 3D space may be implemented, as opposed to a single focused spot. For instance, the PSF (i.e., the local peak or peaks) may follow the shape of a straight line, a spiral, a parabolic or hyperbolic curve, curve segments, or multiple foci (spots).

Some embodiments herein include a mask implemented in an optical element, the optical element implemented as an integral part of an ePSF objective lens, placed between other lenses, behind, or in front of them. If the mask (of the optical element) is placed in a pupil plane, is may create approximate isoplanatic systems. If placed in other locations, it may create non-isoplanatic systems. In some embodiments, the mask may be integrated with, on, or in one or more of the lenses of the unmodified objective lens design, thus producing, for instance, diffractive-refractive elements/pairs, aspheric, or free-form optical elements. The mask may be integrated with the objective lens to achieve optimal performance. The mask and/or one or more lenses of the objective lens may operate in a reflection mode or in some other manner.

The overall optical response of other PSF engineering approaches place a mask in a non-integrated system and cannot be optimized because the specifics of the objective lens (off the shelf, or otherwise) are not taken into account. In comparison, embodiments herein include the objective lens (and any/all of its components) in the overall design optimization of the ePSF (e.g., phase, amplitude, or polarization) and the resulting optimized masks may be physically integrated with or within the ePSF objective lens.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

The figures provided may not show various supporting components, including optical mounts, for example, of the optical systems and/or objective lenses described herein. It will be appreciated by those skilled in the optical arts, with the benefit of the present disclosure, that embodiments of the present invention may use any of a number of types of standard or custom mounts and support components for one or more of the elements included in a given optical system and/or objective lens.

In the context of the present disclosure, the term “approximately” or “about”, when used with reference to a measurement, means within expected tolerances for measurement error and inaccuracy that are accepted in practice. Some reasonable tolerance must be allowed, for example, for measurement differences and for the precision required in a particular application.

In the context of the present disclosure, the term “engineered point spread function (ePSF)” relates to an aspect of an optical system that modifies the conventional (an “Airy Disk” at focus) point spread function (PSF) by manipulating wavefront, phase, amplitude, polarization, spectral response, and/or one or more other light characteristics.

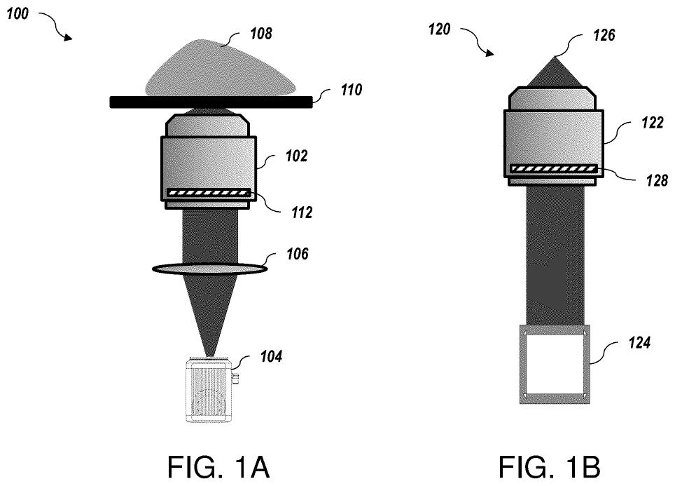

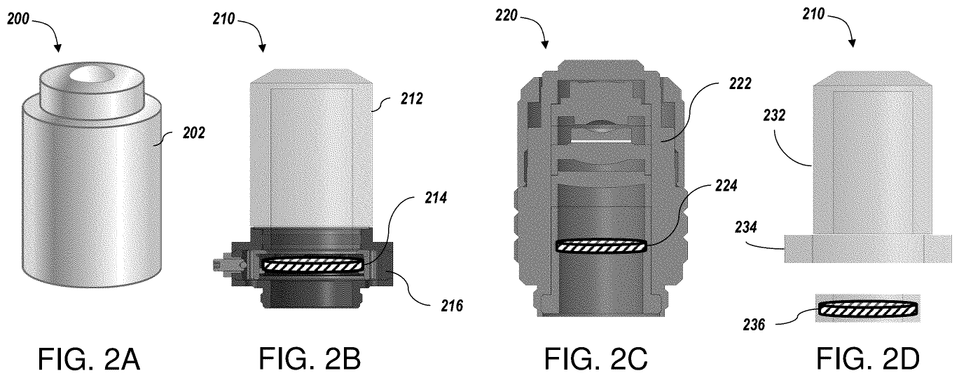

FIG. 1A illustrates an example optical system 100, in accordance with at least one embodiment described in the present disclosure. The optical system 100 may be configured to extract information corresponding to a sample 108. In some embodiments, the optical system 100 may include an objective lens 102, a detector 104, a collimating lens 106, and a dish 110. The sample 108 may be physically positioned on the dish 110 (e.g., a coverslip, a petri dish, a multi-well imaging plate, or the like). The objective lens 102 may include any appropriate objective lens. The optical system 100 may include an optical element 112. The optical element 112 may include a phase mask or other mask optically coupled with the objective lens 102, the optical element 112 configured to impart an ePSF to the optical system 100.

The objective lens 102 is illustrated in FIG. 1A as housing (e.g., including) the optical element 112 for example purposes. In other embodiments, the optical element 112 may include or be included in a device or component that is separate from the objective lens 102. For example, the optical element 112 may be included in a component configured to interface with (e.g., optically couple and physically attach to) an exterior of the objective lens 102.

In some embodiments, the optical system 100 may further include a light source configured to illuminate the sample 108. In these and other embodiments, the light projected to the sample 108 by the light source may be reflected or modified as the light contacts the sample 108. Light rays from the sample 108 may traverse the dish 110, the objective lens 102, and the collimating lens 106 and be captured by the detector 104 to form an image. The light rays from the sample 108 may include reflected light rays (e.g., light rays reflected by the sample 108), transmitted light rays (e.g., light rays transmitted through the sample 108), fluorescence light rays (e.g., light rays emitted from the sample 108 via fluorescence), and/or other light rays which may be used to image the sample 108. More generally, light rays that reach the detector 104 from the sample 108 may include, involve, or result from luminescence, scattering, absorption, polarization, phase shift, two or multi-photo fluorescence, high harmonic generation, refraction, and/or diffraction at or from objects in the sample 108. Characteristics of the image captured by the detector 104 may be based on the image resolution, the magnification, the lateral field of view, the depth of field, or other aspects defined by the objective lens 102.

In some embodiments, the optical element 112 may include a non-traditional optics device (e.g., a dielectric phase mask), which may be placed in an optical path of the optical system 100. The optical element 112 may extend the depth of field defined by the objective lens 102, maintain an image resolution defined by the objective lens 102, maintain light throughput, or some combination thereof to permit the detector 104 to capture an image representative of the sample 108 (or objects therein) within the extended depth of field.

The detector 104 may include any detector suitable for capturing and/or generating images from light received from the objective lens 102. For example, the detector 104 may include a camera, a single-photon avalanche diode (SPAD) array, a complementary metal-oxide-semiconductor (CMOS) active-pixel sensor (APS), a charge-coupled device (CCD) image sensor, or other suitable detector.

In some embodiments, the optical system 100 may further include a computing system (not shown in FIG. 1A) communicatively coupled to the detector 104. The computing device may receive the image representative of the sample 108 within the extended depth of field captured by the detector 104. In some embodiments, the computing device may be configured to estimate properties of one or more objects within the image. For example, the computing device may be configured to estimate properties of the sample 108. In some embodiments, the properties may include one or more of detection of objects, determination of number of the objects, classification of the objects, 2D localization of the objects, 3D localization of the objects, 2D tracking of the objects and/or 3D tracking of the objects.

In FIG. 1A the objective lens 102 may be used for an imaging application. Example imaging applications include imaging modalities such as fluorescence microscopy, bright field microscopy, dark field microscopy, phase contrast microscopy, Raman microscopy, etc. Example imaging applications also include imaging methods such as widefield microscopy, confocal microscopy, two-photon microscopy, STED, SIM, SMLM, or the like or any combination thereof.

FIG. 1B illustrates another example optical system 120, in accordance with at least one embodiment described in the present disclosure. The optical system 120 may be configured to direct light to a focal point 126 on a focal plane. The optical system 120 may include an objective lens 122 and a light source 124. The objective lens 122 may include an optical element 128. The optical element 128 may include a non-traditional optics device (e.g., a dielectric phase mask), which may be placed in an optical path of the optical system 120, or more generally a mask or other optical element to modify a PSF of the optical system 120 such that the optical system 120 has an ePSF.

The objective lens 122 is illustrated in FIG. 1B as housing (e.g., including) the optical element 128 for example purposes. In other embodiments, the optical element 128 may include or be included a device or component that is separate (e.g., a separate optical imaging device) from the objective lens 122. For example, the optical element 128 may be included in a component configured to interface with (e.g., optically couple and physically attach to) an exterior of the objective lens 122.

In FIG. 1B the objective lens 122 may be used for an illumination application. Example illumination applications include two-photon illumination, STED illumination, light-sheet illumination, extended depth of focus illumination, or the like or any combination thereof.

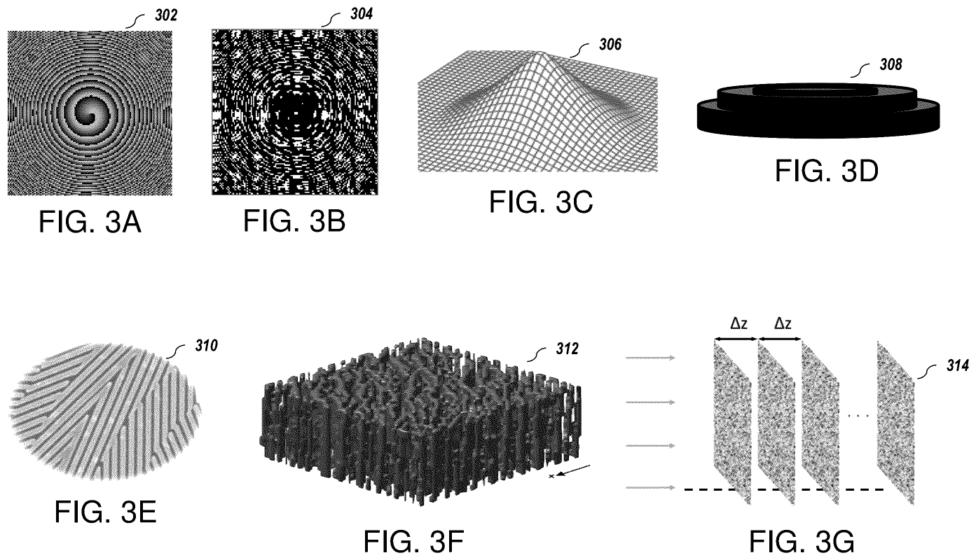

FIG. 2A illustrates an example objective lens 200, in accordance with at least one embodiment described in the present disclosure. The objective lens 200 may include one or more lenses disposed within an outer body 202 configured to house the one or more lenses. For example, in some embodiments, the objective lens 200 may include a front lens, one or more lens doublets, one or more lens triplets, a meniscus lens, or any combination thereof. In some embodiments, the one or more lenses may be separated by lens spacers. For example, lens spacers may be placed between the one or more lenses to control space between the lenses which may increase or decrease magnification of the objective lens 200.

FIG. 2B illustrates another example objective lens 210 in accordance with at least one embodiment described in the present disclosure. The objective lens 210 may include an outer body 212 housing one or more lenses. In some embodiments, a PSF of the objective lens 210 may be modified by an optical element 214 to impart an ePSF to the objective lens 210 and/or to a corresponding optical system. In some embodiments, the optical element 214 may be integrated with the objective lens 210 outside of the outer body 212. For example, the optical element 214 may be placed inside a connector or attachment 216 which may be removably attached to the outer body 212. The connector 216 may be attached to the outer body 212 and/or a pupil plane of the objective lens 210 may be outside of the outer body 212. For example, the pupil plane may be located where the optical element 214 may be placed or at other location. In some embodiments, the optical element 224 may be placed in other planes within the objective lens 210. In some embodiments, the optical element 214 may include one or more masks.

FIG. 2C illustrates another example objective lens 220 in accordance with at least one embodiment described in the present disclosure. The objective lens 220 may include at least an outer body 222 and one or more lenses. In some embodiments, a PSF of the objective lens 220 may be modified by an optical element 224 to impart an ePSF to the objective lens 210 and/or to a corresponding optical system. In some embodiments, the optical element 224 may be placed inside the outer body 222 of the objective lens 220. For example, the optical element may be located in a pupil plane, where the pupil plane lies inside the outer body 222. In some embodiments, the optical element 224 may be placed in other planes within the objective lens 220. For example, the optical element 224 may be placed in an image plane or a back focal plane of the objective lens 220. In some embodiments, the optical element 224 may be placed between the one or more lenses of the objective lens. In some embodiments, the optical element 224 may include one or more masks.

FIG. 2D illustrates another example objective lens 230 in accordance with at least one embodiment described in the present disclosure. The objective lens 230 may include at least an outer body 232 and an objective lens mount 234. In some embodiments, the outer body 232 may be mounted to the objective lens mount 234. In some embodiments, a PSF of the objective lens 230 may be modified by an optical element 236 to impart an ePSF to the objective lens 210 and/or to a corresponding optical system. In some embodiments, the optical element 236 may be designed to be located in various planes. In some embodiments, the optical element 236 may be located in a plane external to the outer body 232. For example, the optical element 236 may be housed by an external device, the external device configured to place the optical element 236 within a plane outside of the outer body 232. As a particular example, the optical element 236 may be placed in a differential interference contract (DIC) slot. In these and other embodiments, the optical element 236 may not need to be physically attached to the outer body 232. In some embodiments, the optical element 236 may include one or more masks.

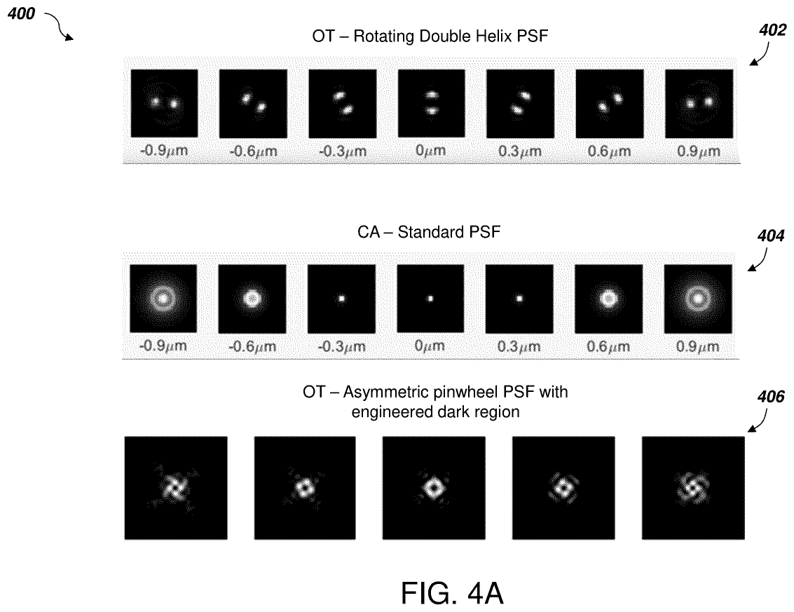

FIGS. 3A-3G illustrate some example masks that may be implemented in an optical element that may be placed with an objective lens of an optical system to modify PSF, arranged in accordance with at least one embodiment herein. Alternatively or additionally, the optical element may include two or more masks, such as two or more of the masks of FIGS. 3A-3G. In more detail, FIG. 3A illustrates an example diffractive dielectric phase mask 302, FIG. 3B illustrates an example diffractive mask 304 with binary amplitude modulation, FIG. 3C illustrates an example refractive aspheric and freeform mask 306, and FIG. 3D illustrates an example refractive piecewise constant mask 308. Further, FIG. 3E illustrates an example metasurface mask 310, FIG. 3F illustrates an example volumetric mask 312, and FIG. 3E illustrates an example multi-plane mask 314 (in which multiple masks are cascaded at different locations within the objective lens). In some embodiments, the one or more masks may be implemented by diffractive optic, refractive optics, holographic optics, metasurface optics, aspheric optics, free-form options, one or more spatial light modulators, deformable mirrors, deformable lenses, and/or prism arrays. The one or more masks may include any other suitable masks configured to modify the PSF of the optical system. The one or more masks may be optically transparent, reflective, photo efficient, or some combination thereof. In general, the one or more masks may modify a PSF of the objective lens and/or of the optical system in which the objective lens is used.

Metasurfaces include thin nanostructured optical elements with features that control light propagation at the sub-wavelength level. Metasurfaces' effective dielectric and magnetic permittivity, including their spectral characteristics, is tailored by material composition, intrinsic and extrinsic resonances, feature size, and surrounding conditions. As a result, metasurface masks, similarly to diffractive optics, can be designed to modulate any property of light, including phase (i.e., delays), amplitude, polarization, spectral response, or the like or any combination thereof. One possible approach is to create localized gratings (typically dielectric) with different orientations to locally exert different delays for each linear polarization. This method enables local control of the polarization state and generates a vectorial PSF, namely a PSF that is different for each orthogonal polarization state (either linear or circular). Further control of an ePSF may be achieved, for instance, with spectral control via absorption or dispersion, intrinsic or extrinsic.

In some embodiments, the optical element may be designed in a way to optimize efficiency of the optical system. For example, one or more performance criteria may be considered in designing the optical element. In some instances, the one or more performance criteria may include one or more of light efficiency, extended depth of field while maintaining lateral (XY) resolution, depth invariant PSF, and/or spectral response. The optical element designed with light efficiency may ensure that most of incident light (e.g., >95%) on the objective lens forms part of a usable signal. As for extended depth of field while maintaining lateral resolution, the lateral size of the PSF, as well as the zeroes of its Fourier transform, may determine the resolution and information transfer/loss; the PSF may be optimized to be confined, maintaining a diffraction-limited spot size. Regarding depth invariant PSF, traditional microscope objective lenses are designed to be shift-invariant at the focal plane, meaning that the PSF does not change when an object (source) at focus is shifted laterally; the optimization may further ensure that the PSF is approximately depth invariant, leading to uniform resolution across the desired depth of field. Regarding spectral response, the PSF may be designed to work across the entire visible spectrum to ensure that the PSF is well matched to chromatic correction of the objective lens, thus enabling imaging across a wide variety of modalities (e.g., fluorescence, bright field, dark field, etc.).

In some embodiments, the objective lens including the optical element may be optimized based on metrics that define performance for multiple planes instead of solely in a focal plane. In these and other embodiments, the PSF may be evaluated at different locations in 3D space and optimized across various constraints considering joint design of the objective lens, the optical element (and/or the mask), and/or any other lenses. An important subset of target 3D PSF engineering entails obtaining, as close as possible, a diffraction limited PSF at multiple depths and over a wide field of view. For example, the PSF may be optimized to reduce aberrations in multiple depth planes and over a specified field of view for each plane. An alternative optimization of aberrations may seek to attain an optimum over a whole 3D volume. A resulting optimized ePSF objective lens may require tradeoffs, namely, while aberrations may not be eliminated over the whole volume, they may be reduced to a significant extent well beyond what is possible with classical focal plane optimization.

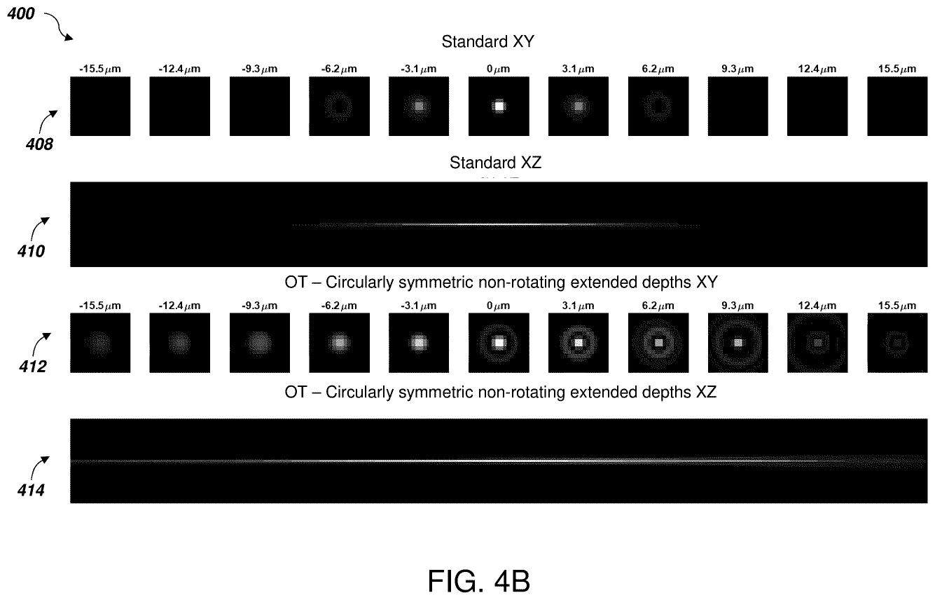

FIGS. 4A-4B illustrate graphical representations 400 of simulations 402, 404, 406, 408, 410, 412, 414 of various axially varying PSFs such as may be implemented in an optical system, such as the optical system 100 of FIG. 1A, in accordance with at least one embodiment described in the present disclosure.

The simulation 402 is for an optimized tailored (OT) Double Helix PSF (DH-PSF) such as may be exhibited by and/or included in the optical system 100 of FIG. 1A by incorporation of the optical element 112 with a suitable mask. A point source imaged through the OT DH-PSF resembles two spots where an angle of a line between the spots relative to a reference line changes as a function of axial position of the point source relative to the focal plane. The simulation 402 of the DH-PSF includes data points for the point source imaged at various axial depths relative to a focal plane, specifically at (from left to right) −0.9 micrometers (μm), −0.6 μm, −0.3 μm, 0 μm (this represents the focal plane), 0.3 μm, 0.6 μm, and 0.9 μm.

The simulation 406 is for an OT asymmetric pinwheel PSF with engineered dark region such as may be exhibited by and/or included in the optical system 100 of FIG. 1A by incorporation of the optical element 112 with a suitable mask. The OT asymmetric pinwheel PSF resembles a pinwheel where angular rotation and pinwheel arm length and direction of the pinwheel changes as a function of axial position of a corresponding point source.

The simulations 404, 408, and 410 are related as each is for a standard PSF such as may be exhibited by and/or included in a standard optical system without an optical element that includes a mask, such as without the optical element 112 of FIG. 1A. The simulation 404 includes data points for a point source imaged through the standard PSF at various axial depths relative to the focal plane, i.e., the same axial depths relative to the focal plane as in the simulation 402 for the OT DH-PSF. The simulation 408 includes data points for the point source at different locations in an XY plane (i.e., at the focal plane which is orthogonal to the optical or z axis of the optical system) imaged through the standard PSF specifically at (from left to right) −15.5 μm, −12.4 μm, −9.3 μm, −6.2 μm, −3.1 μm, 0 μm (this represents the center of the focal plane), 3.1 μm, 6.2 μm, 9.3 μm, 12.4 μm, and, 15.5 μm. The simulation 410 represents the standard PSF in the XZ plane.

The simulations 412, 414 are related as both are for an OT circularly symmetric non-rotating extended depths PSF such as may be exhibited by and/or included in the optical system 100 of FIG. 1A by incorporation of the optical element 112 with a suitable mask. The simulation 412 includes data points for the point source at different locations in an XY plane (i.e., at the focal plane) imaged through the OT circularly symmetric non-rotating extended depths PSF at various distances from the center of the XY plane, i.e., the same locations in the focal plane relative to the center as in the simulation 408 for the standard PSF. The simulation 414 represents the OT circularly symmetric non-rotating extended depths PSF in the XZ plane.

It is evident from FIGS. 4A-4B, including at least from a comparison of the simulation 410 for the standard PSF to the simulation 414 for the OT circularly symmetric non-rotating extended depths PSF that the depth of field of the OT circularly symmetric non-rotating extended depths PSF is much larger than (e.g., extended compared to) the depth of field of the standard PSF. The lateral field of view of the OT circularly symmetric non-rotating extended depths PSF is also much larger than (e.g., extended compared to) the lateral field of view of the standard PSF, as indicated by a comparison of the simulations 408 and 412.

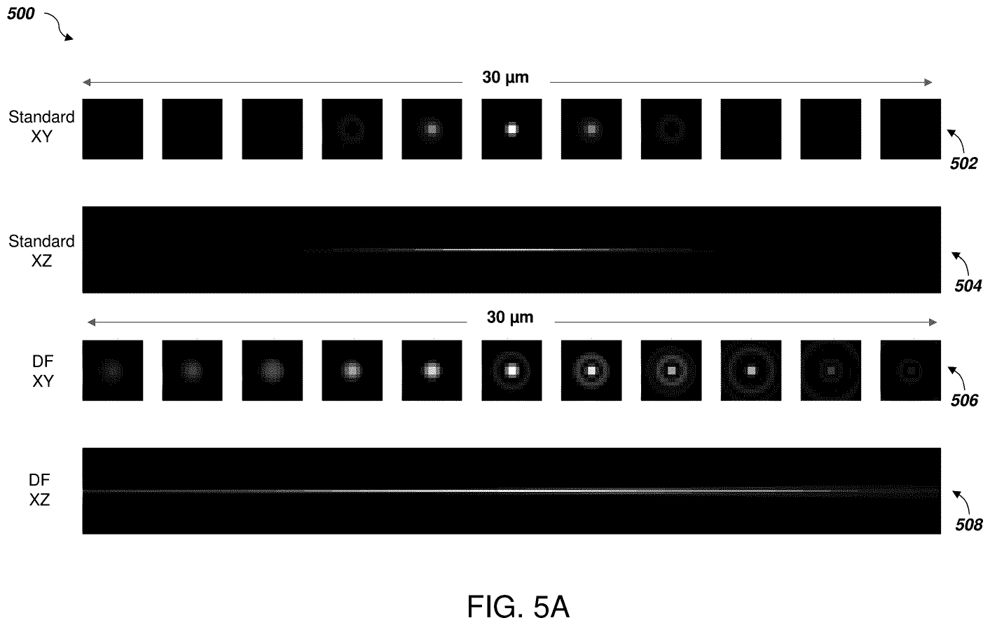

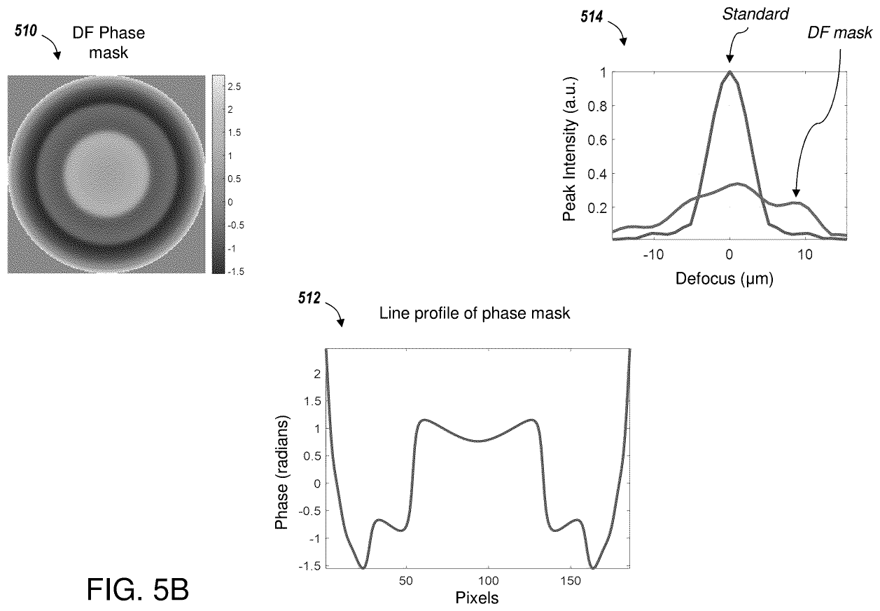

FIG. 5A illustrates graphical representations 500 of simulations 502, 504, 506, 508 of PSFs such as may be implemented in an optical system, such as the optical system 100 of FIG. 1A, in accordance with at least one embodiment described in the present disclosure. The simulations 502, 504 represent the PSF of an optical system with a standard PSF in, respectively, the XY plane and the XZ plane, while the simulations 506, 508 represent the PSF of an optical system with a Deep Focus (DF) PSF in, respectively, the XY plane and the XZ plane. The DF PSF is an example of an ePSF such as described herein. In more detail, the simulations 502, 504 were performed for an optical system that includes an Airy Disc PSF 20x/0.45NA objective lens (e.g., an optical system that lacks a mask such as may be included in the optical element 112 of FIG. 1A), while the simulations 506, 508 were performed for an optical system that includes a DF ePSF optical element (such as the optical element 112) designed for the Airy Disc PSF 20x/0.45NA objective lens. The data points in the simulation 506 are normalized to the brightest data point at the original focal plane. The optical element for the simulations 506, 508 was designed to extend the depth of field by a factor of roughly three times compared to the simulations 502, 504.

FIG. 5B illustrates a phase mask of the optical element used for the simulations 506, 508 in graphic 510 (labeled “DF Phase Mask”) and includes a circularly symmetric pattern that maintains circular symmetry of the DF PSF relative to the standard PSF. Graphic 512 in FIG. 5B illustrates a line profile (labeled “Line profile of phase mask”) across a center of the phase mask illustrated in graphic 510. Graphic 514 in FIG. 5B illustrates intensity of a clear aperture (CA), or objective lens with an unmodified standard PSF, over the extended depth of field for the optical system with the standard PSF (labeled “Standard” in graphic 514) compared to that of the optical system with the DF ePSF (labeled “DF mask”).

As is evident, the DF ePSF extends the depth of field to over 15 μm (e.g., in the region from about −6 μm to about 10 μm) while largely maintaining the resolving power of the PSF, as indicated by at least the “DF mask” curve in the graphic 514. However, due to conservation of energy, this extended depth of field naturally trades off in a drop in the peak intensity of the DF ePSF relative to the peak intensity of the standard PSF. As can be seen in the graphic 514, the peak intensity of the DF ePSF at focus is about ⅓ of that of the standard airy disk PSF, showing that the DF ePSF conserves the energy with minimal losses to side lobes. However, away from focus, the peak intensity of the DF ePSF is higher than the standard PSF, resulting in higher SNR away from focus and a greater full width at half maximum (FWHM) for the DF ePSF compared to the standard PSF. In this example, the FWHM for the DF ePSF is about 18 μm while the FWHM for the standard PSF is about 6 μm.

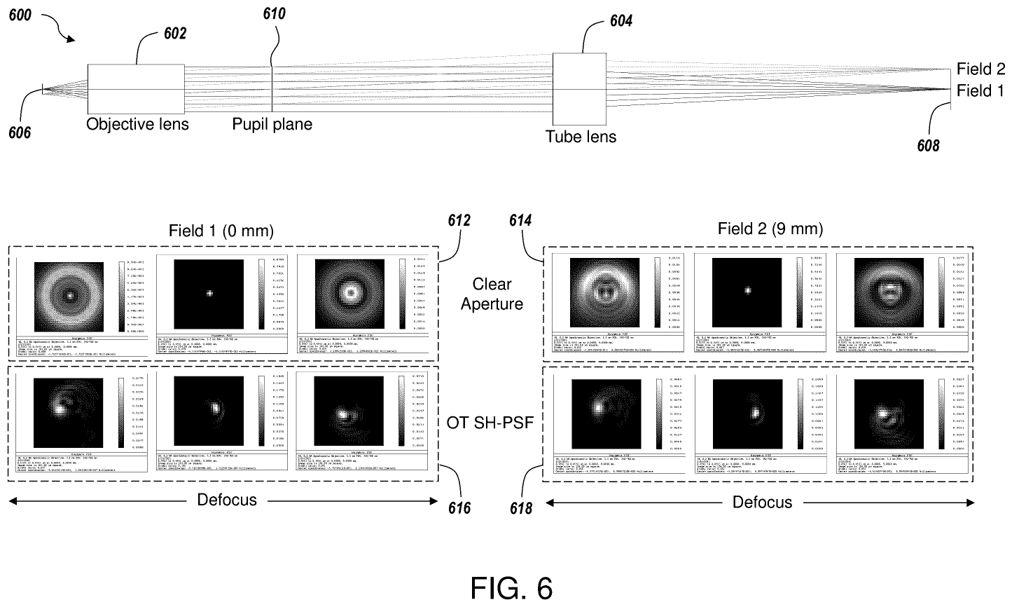

FIG. 6 illustrates an infinity-corrected optical system 600 that includes an objective lens 602 and a tube lens 604 together with a corresponding ray tracing simulation, in accordance with at least one embodiment described herein. The ray tracing simulation was generated using a ray tracing tool, i.e., ZEMAX OPTICS STUDIO in this case. Rays were traced from two points on object plane 606 to two corresponding field points (e.g., Field 1 and Field 2) on a magnified image plane 608. Field 1 is on axis (or at 0 mm) and Field 2 is 9 mm from Field 1 at the image plane 608. The optical system 600 further includes an optical element 610 placed in a pupil plane of the optical system 600. The optical element 610 in this example includes an OT Single Helix (SH) phase mask (OT SH-PSF) resulting in the optical system 600 having an OT SH-PSF. Physical optics simulation was then used to model the OT SH-PSF as a function of distance of the object plane 606 from the objective lens 602, both with and without the mask (i.e., with and without the optical element 610 in this case), thus showing the effect of the mask and field aberrations on the PSF of the optical system 600. In particular, FIG. 6 includes physical optics simulations 612, 614 for Field 1 and Field 2 of the optical system 600 without the mask (i.e., without the optical element 610). FIG. 6 also includes physical optics simulations 616, 618 for Field 1 and Field 2 of the optical system 600 with the mask (i.e., with the optical element 610).

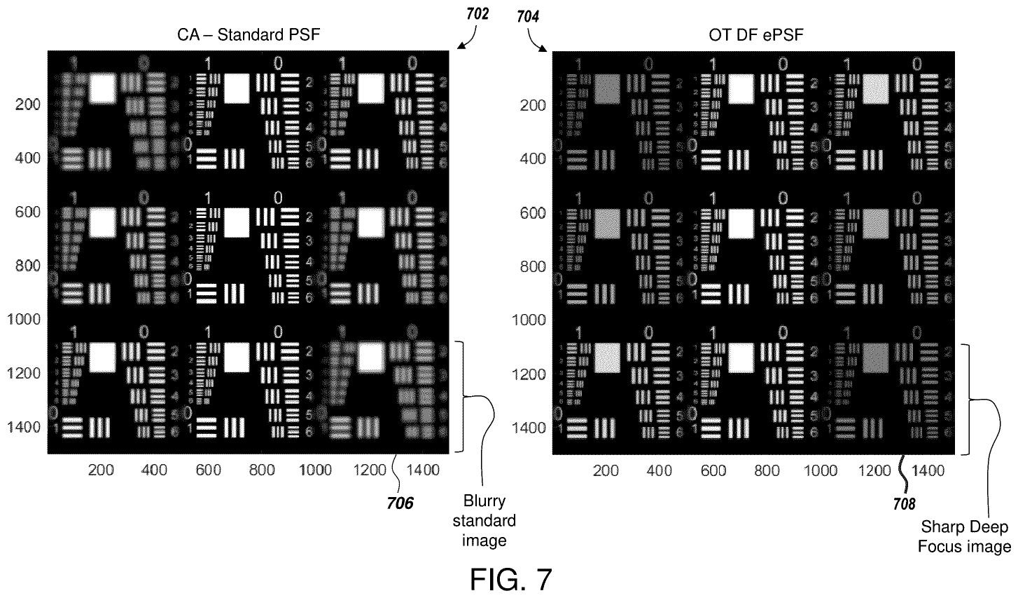

FIG. 7 illustrates synthetic images 702, 704 of a US Air Force (USAF) 1951 target, in accordance with at least one embodiment described herein. The USAF 1951 target is a microscopic optical resolution test device used to analyze and validate performance of optical systems. The synthetic images 702, 704 were created using a 3×3 panel of the USAF 1951 target with increasing defocus. In each of the synthetic images 702, 704, the center of the 3×3 panel represents the in-focus image. The synthetic image 702 was generated using a microscope with an unmodified objective lens with a standard PSF. The synthetic image 704 was generated using a microscope with an ePSF objective lens, particularly an objective lens with an OT DF PSF. The synthetic images 702, 704 include scale bars along their left and bottom edges. The OT DF ePSF objective lens clearly shows a higher resolution over an extended depth of field than the unmodified objective lens. For example, a last panel 706 of the synthetic image 702 generated using the unmodified objective lens shows a blurry image while a corresponding last panel 708 of the synthetic image 704 generated using the OT DF ePSF objective lens shows a sharp deep focus image.

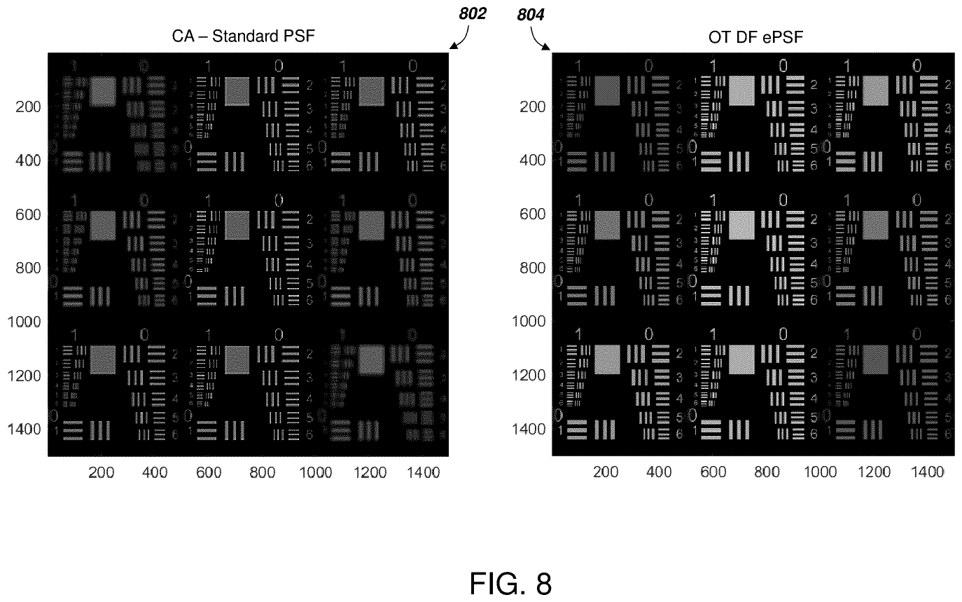

FIG. 8 illustrates recovered images 802, 804 generated by applying a computational recovery algorithm to the synthetic images 702, 704 of FIG. 7, arranged in accordance with at least one embodiment described herein. In some embodiments, the computational recovery algorithm may deblur and restore image resolution. For example, the computational recovery algorithm may include a deconvolution algorithm configured to retore spatial organization of the image (energy), thus improving image contrast. In some embodiments, the deconvolution algorithm may be applied using any suitable computational device. The recovered image 802 is for the standard PSF case (e.g., the synthetic image 702 generated using the unmodified objective lens with standard PSF) while the recovered image 804 is for the OT DF ePSF case (e.g., the synthetic image 704 generated using the OT DF ePSF objective lens). As illustrated in FIG. 8, improvement in contrast through the deconvolution algorithm is more pronounced for the OT DF ePSF case owing to a larger spatial frequency cutoff of the OT DF ePSF. Methods of applying computational recovery algorithms are further discussed elsewhere herein.

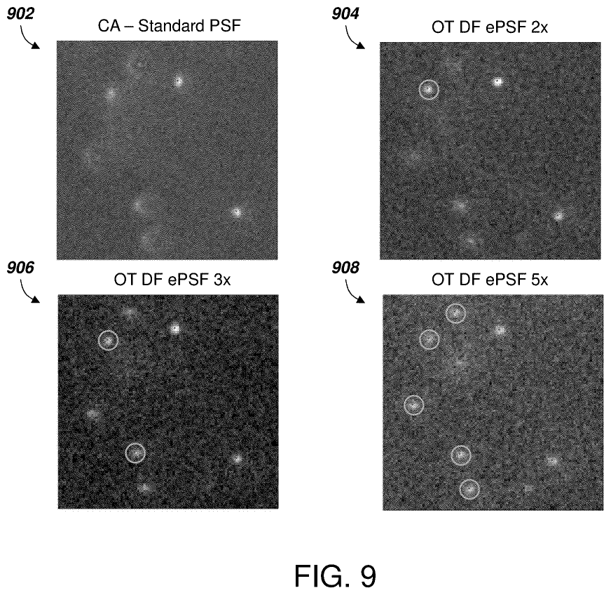

FIG. 9 illustrates images 902, 904, 906, 908 of a 3D distribution of fluorescent beads in agarose, arranged in accordance with at least one embodiment described herein. The images 902, 904, 906, 908 were generated using a CA standard PSF (specifically an objective lens with a CA standard PSF) and various OT DF ePSFs (specifically objective lenses with various OT DF ePSFs) with various depths of field. In particular, the image 902 was generated using a CA standard PSF, the image 904 was generated using an OT DF ePSF with a 2× depth of field (or a depth of field twice that of the CA standard PSF), the image 906 was generated using an OT DF ePSF with a 3× depth of field (or a depth of field three times that of the CA standard PSF), and the image 908 was generated using an OT DF ePSF with a 5× depth of field (or a depth of field five times that of the CA standard PSF). The 3D distribution of beads in agarose was the same for each image. The depth resolution improves with each successive image 904, 906, 908 relative to the preceding image 902, 904, 906.

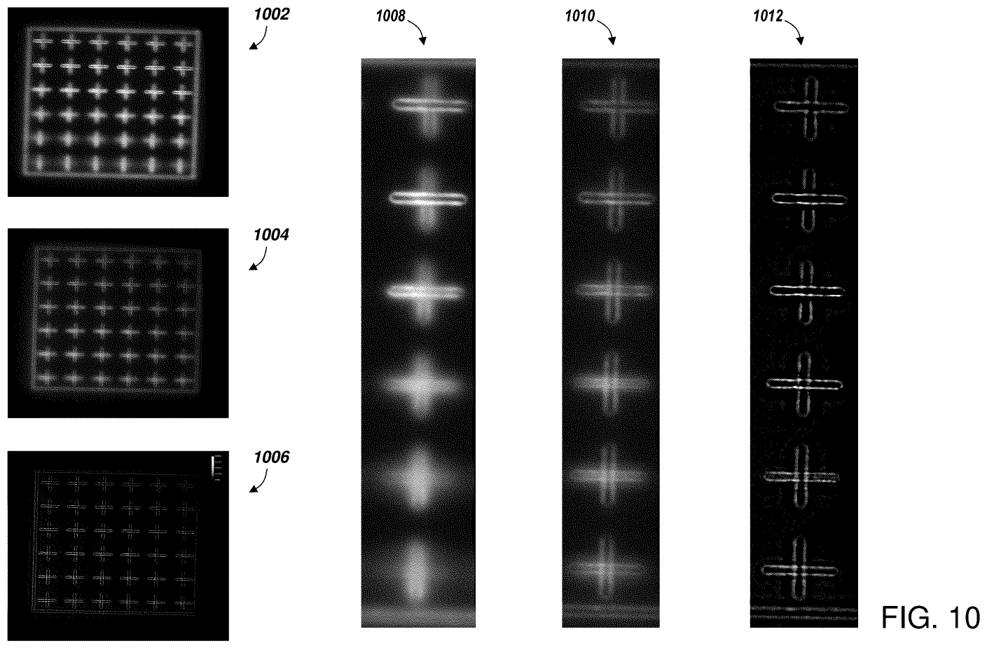

FIG. 10 includes images 1002, 1004, 1006, 1008, 1010, 1012 that illustrate the effect of an objective lens with an OT DF ePSF on a 3D fluorescent object, arranged in accordance with at least one embodiment described herein. The 3D fluorescent object in this example is a fluorescent slide in the form of a commercially available target sold by Argolight. The fluorescent slide consists of a matrix of 6×6 crosses, where the length of each cross is 5 μm. The crosses are composed of vertical lines that are in the same plane, and horizontal lines going gradually deeper within the slide. The spacing between the vertical and horizontal lines gradually increases, going from 0 to 3.5 μm, with 100 nanometer (nm) steps.

The image 1002 was generated using an unmodified objective lens, i.e., having a CA standard PSF. The limited depth of field of the unmodified objective lens is apparent from the image 1002.

The image 1004 was generated using an ePSF objective lens, in this example an objective lens having an OT DF ePSF. The depth of field of the ePSF objective lens is significantly greater than that of the unmodified objective lens, as can be seen from comparing the image 1004 to the image 1002.

The image 1006 is a recovered image generated by applying a computational recovery algorithm specific to the known OT DF ePSF to the image 1004 to further improve image contrast. In this example, the computational recovery algorithm includes deconvolving the image 1004.

The images 1008, 1010, and 1012 are detailed views of portions of, respectively, the images 1002, 1004, and 1006.

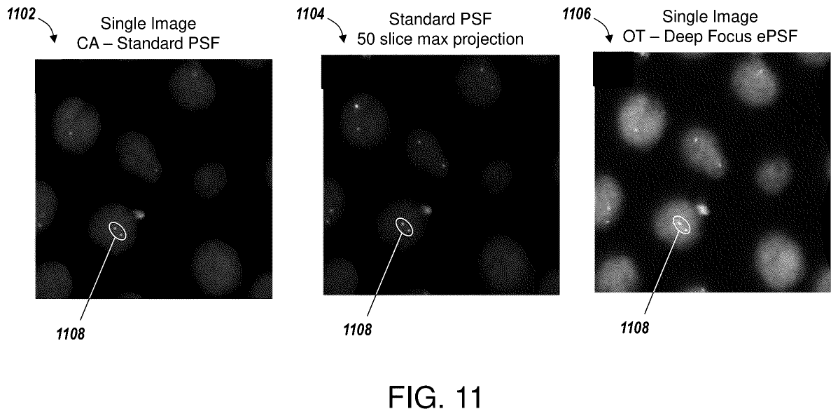

FIG. 11 includes experimental data comparing unmodified and extended depth of field ePSF objective lenses for high throughput imaging of genomic loci in fixed cells to investigate mRNA mechanisms, arranged in accordance with at least one embodiment described herein. A first image 1102 is a single 2D image generated using an unmodified objective lens, i.e., having a CA standard PSF. A second image 1104 is a maximum intensity projection of an axial stack captured using the unmodified objective lens having the CA standard PSF. A third image 1104 is a single 2D image generated using an ePSF objective lens having an OT DF ePSF.

In each image 1102, 1104, 1106, genomic loci show up as bright spots above the background of the cell. Two loci visible in each of the images 1102, 1104, 1106 are collectively indicated at 1108 in each of the images 1102, 1104, 1106. The maximum intensity projection, i.e., the image 1104, shows that there were about 10 loci in the total cell volume. However, the single 2D clear aperture image, i.e., the image 1102, captured only about 5 of them, whereas the other loci were too far out of focus to be imaged by the unmodified objective lens having the CA standard PSF and thus are part of the background in the image 1102. The 2D OT DF ePSF objective lens image, i.e., the image 1106, reveals at least 8 loci in a single image capture, clearly demonstrating a significant improvement of the OT DF ePSF objective lens as compared to the unmodified objective lens.

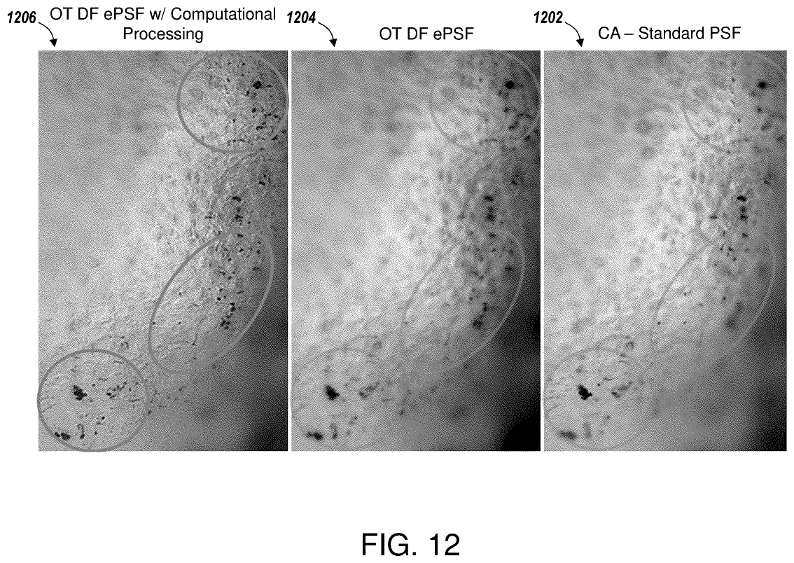

FIG. 12 includes experimental data comparing unmodified and extended depth of field ePSF objective lenses for use in Ca+ signaling in bone, arranged in accordance with at least one embodiment described herein. A first image 1202 was generated using an unmodified objective lens, i.e., having a CA standard PSF. A second image 1204 was generated using an ePSF objective lens having an OT DF ePSF. A third image 1206 was generated by applying a computational recovery algorithm to the second image 1204. In FIG. 12, the object imaged in the images 1202. 1204, 1206 is a mouse femur imaged with contrast. The images 1202, 1204, 1206 show the extended depth and detail enabled by the OT-DF ePSF.

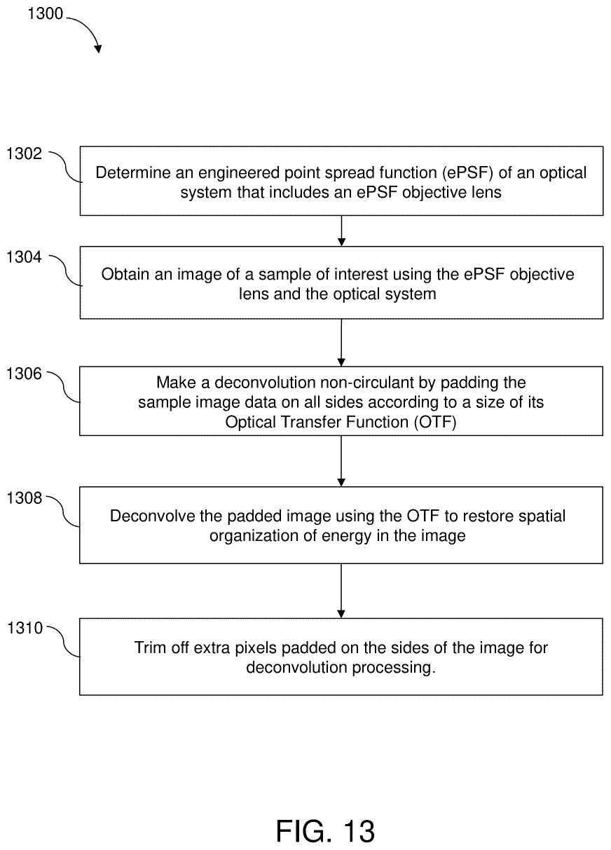

FIG. 13 illustrates a flow chart of an example method 1300 of applying a computational recovery algorithm to an image, in accordance with one or more embodiments of the present disclosure. One or more operations of the method 1300 may be performed or controlled by any suitable system, apparatus, or device such as, for example, computing devices(s) described with respect to FIG. 10 of the present disclosure. The method 1300 may include one or more of blocks 1302, 1304, 1306, 1308, 1310, and/or other blocks. Although illustrated with discrete blocks, the operations associated with one or more of the blocks of the method 1300 may be divided into additional blocks, combined into fewer blocks, or eliminated, depending on the particular implementation.

At block 1302, the method may include determining an ePSF of an optical system that includes an ePSF objective lens. In some embodiments, the ePSF may be determined empirically, e.g., by imaging one or more sub-diffraction limit fluorescent microspheres using the optical system, and/or by taking a Z stack image of one or more sub-diffraction-limit point source emitters to characterize the ePSF. In some embodiments, the ePSF may be theoretically computed based on modeling of the ePSF objective lens and/or the optical system. For example, with an accurate model of the ePSF objective lens and the optical system, and/or by accurately modeling the ePSF objective lens and the optical system, a theoretical model of the ePSF may be computed.

At block 1304, an image of a sample of interest may be obtained using the ePSF objective lens and the optical system. For example, as illustrated in FIG. 1A of the present disclosure, the optical system 100 including the objective lens 102 with the optical element 112 may obtain an image of the sample 108.

At block 1306, a deconvolution may be made non-circulant. The deconvolution may be made non-circulant by, e.g., padding the image obtained at block 1304 on all sides according to a size of its Optical Transfer Function (OTF). Padding the image may include adding extra pixels on all four sides of the image.

At block 1308, the padded image may be deconvolved using the OTF, e.g., to restore spatial organization of energy in the image.

At block 1310, extra pixels padded on the sides of the image for deconvolution processing may be trimmed off. For example, any additional pixels not used up during the deconvolution processing may be removed to leave the recovered image by itself.

Modifications, additions, or omissions may be made to the method 1300 without departing from the scope of the present disclosure. For example, the operations of method 1300 may be implemented in differing order. Additionally or alternatively, two or more operations may be performed at the same time. Furthermore, the outline operations and actions are only provided as examples, and some of the operations and actions may be optional, combined into fewer operations and actions, or expanded into additional operations and actions without detracting from the essence of the described embodiments.

The computational recovery algorithm of FIG. 13 is only one example that may be implemented in connection with the ePSFs described herein and other recovery algorithms may be implemented. For example, constrained optimization algorithms including gradient descend algorithms, genetic algorithms, convex and nonconvex optimization, simulated annealing, and convolutional neural networks may be implemented in connection with the ePSFs described herein. Alternatively or additionally, many implementations of machine learning can train the system to provide images of the object or sample from the outputs obtained by the ePSF objective lens.

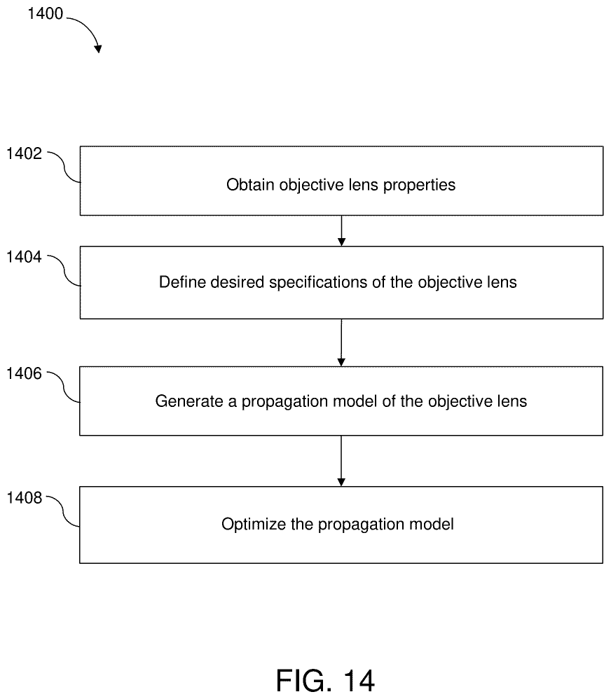

FIG. 14 illustrates a flow chart of an example method 1400 of optimizing an objective lens, in accordance with one or more embodiments of the present disclosure. One or more operations of the method 1400 may be performed or controlled by any suitable system, apparatus, or device such as, for example, computing device(s) described with respect to FIG. 10 of the present disclosure. The method 1400 may include one or more of blocks 1402, 1404, 1406, 1408 and/or other blocks. Although illustrated with discrete blocks, the operations associated with one or more of the blocks of the method 1400 may be divided into additional blocks, combined into fewer blocks, or eliminated, depending on the particular implementation.

At block 1402, objective lens properties may be obtained and/or determined. The objective lens properties may include any characteristics of the objective lens that may define and/or limit performance of the objective lens. For example, the objective lens properties may include magnification, numerical aperture (NA), construction, field of view, cover slip thickness, and/or quality correction.

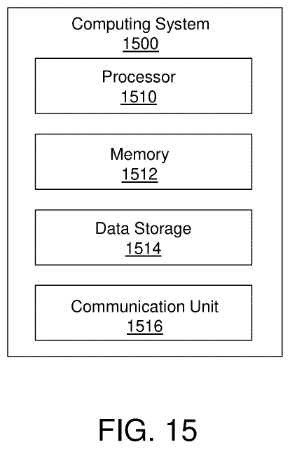

At block 1404, desired specifications of the objective lens may be defined. In some embodiments, the desired specifications may include a PSF shape, a field of view, and/or a depth of field. In some embodiments, the desired specifications may be provided by a user. In other embodiments, the desired specifications may be generated by a computing system such as the computing system 1500 of FIG. 15. In some embodiments, the desired specifications may depend on an intended application of the objective lens.

At block 1406, a propagation model of the objective lens may be generated. In some embodiments, the propagation model may include response of the objective lens to different polarization states of light. In these and other embodiments, the propagation model may describe nanoscale interaction of light with elements of the objective lens. In some embodiments, a design of a mask to be integrated with the objective lens (in an appropriate optical element) may be determined, e.g., by forward and inverse discrete Fourier transforms, and/or may be included in the propagation model. In some embodiments, other external effects may be taken into consideration. For example, apodization and field aberrations may be taken into consideration.

At block 1408, the propagation model and the mask of the optical element may be optimized. In some embodiments, the propagation model and the design of the mask included in the propagation model may be iteratively optimized while comparing current results to desired results. For example, the design of the mask may be modified following results of the propagation model. Following the modification, the propagation model may be tested again. The results of the propagation model may be compared against the desired PSF shape. In some embodiments, a convergence criterion may be evaluated. For example, as the propagation model is iteratively optimized and the results of the propagation model gets closer to the desired PSF shape, the convergence may increase. In some embodiments, iteratively optimizing may include iterating with various aberrations, wavelengths, and/or objective lens properties to create masks that are robust to perturbations.

In these and/or other embodiments, the mask structure may be optimized (e.g., at block 1408) through an algorithm that imposes constraints on the PSF in 2D or 3D, and on the mask structure. The mask structure and the resulting PSF are related by an optical transformation modeled with wave optics, electromagnetic optics, or even geometrical optics. The optimization of the mask and/or the propagation model at block 1408 may be done in one step, or by an iterative process and realized via algorithms such as Gerschberg Saxton, Projection onto constraint sets, Genetic or evolutionary algorithms, convex optimization, gradient descent, simulated annealing, or machine learning approaches.

As for generating the propagation model of the objective lens, e.g., at block 1406, in some embodiments the PSF of the objective lens may be described operationally by equation 1 describing the 3D polarization-dependent response to a dipole \vec{p}:

ψ̅(x,y)= [symbol] {\vec{p}(x,y,z,θ,φ)} Equation 1.

In equation 1, \vec{p}(x, y, z, θ, φ) represents a dipole exploring all possible locations (x, y, z) in a sample (object) space for all possible orientations (θ, φ) of the dipole. [symbol] describes electromagnetic response of the ePSF objective lens and ψ̅(x, y) is polarization-dependent response on a predefined image plane. [symbol] includes all the lenses and masks of the objective lens, which are designed as a whole.

The model of equation 1 may be simplified for scalar waves by considering a point source that explores the sample (object) space according to equation 2:

ψ(x,y)= [symbol] {δ(x,y,z)} Equation 2.

In equation 2, δ is a delta function representing a point source at location (x, y, z). [symbol] is the scalar response of the system including all the lenses and masks of the objective lens, which are designed as a whole. ψ(x, y) is the response on a predefined image plane. Note that traditionally objective lenses are optimized on a single plane (z=z₀), namely for δ(x, y, z)=δ(x, y, z₀).

The foregoing model may also be refined to include partial polarization or dipoles that are allowed to explore different orientations to a certain degree. Interestingly, these cases may be derived from [symbol] above (e.g., in Equation 1).

As described herein, in some embodiments, [symbol] (the ePSF objective lens response), is designed as a whole with more or less sophisticated models that take into account the non-ideal characteristics of each element of the ePSF objective lens. Similarly, the physical design involves an integrated system that results from the optical design and optimization process.

Modifications, additions, or omissions may be made to the method 1400 without departing from the scope of the present disclosure. For example, the operations of method 1400 may be implemented in differing order. Additionally or alternatively, two or more operations may be performed at the same time. Furthermore, the outline operations and actions are only provided as examples, and some of the operations and actions may be optional, combined into fewer operations and actions, or expanded into additional operations and actions without detracting from the essence of the described embodiments.

Embodiments of ePSF objective lenses described herein may be calibrated, for instance, using a pinhole that is moved across the field of view area, or using an array of point-source emitters that covers the desired field of view or is moved across the desired field of view. For each desired axial location, an image of the one or more pinholes or point source emitters may determine the PSF in each localized area of the field of view.

FIG. 15 illustrates a block diagram of an example computing system 1500, according to at least one embodiment of the present disclosure. The computing system 1500 may be configured to implement, perform, direct, and/or control one or more operations associated with a system (e.g., the optical system 100 of FIG. 1A) and/or one or more operations, such as one or more of the operations of the methods 1300, 1400 of FIGS. 13-14. The computing system 1500 may include a processor 1510, a memory 1512, a data storage 1514, and a communication unit 1516. The processor 1510, the memory 1512, the data storage 1514, and the communication unit 1516 may be communicatively coupled.

In general, the processor 1510 may include any suitable special-purpose or general-purpose computer, computing entity, or processing device including various computer hardware or software modules and may be configured to execute instructions stored on any applicable computer-readable storage media. For example, the processor 1510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 15, the processor 1510 may include any number of processors configured to, individually or collectively, perform or direct performance of any number of operations described in the present disclosure. Additionally, one or more of the processors may be present on one or more different electronic devices, such as different servers.

In some embodiments, the processor 1510 may be configured to interpret and/or execute program instructions and/or process data stored in the memory 1512, the data storage 1514, or the memory 1512 and the data storage 1514. In some embodiments, the processor 1510 may fetch program instructions from the data storage 1514 and load the program instructions in the memory 1112. After the program instructions are loaded into memory 1512, the processor 1510 may execute the program instructions to implement operations as directed by the instructions.

The memory 1512 and the data storage 1514 may include computer-readable storage media for carrying or having computer-executable instructions or data structures stored thereon. Such computer-readable storage media may include any available media that may be accessed by a general-purpose or special-purpose computer, such as the processor 1510. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1510 to perform or control performance of a certain operation or group of operations.

The communication unit 1516 may include any component, device, system, or combination thereof that is configured to transmit or receive information over a network. In some embodiments, the communication unit 1516 may communicate with other devices at other locations, the same location, or even other components within the same system. For example, the communication unit 1116 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 1516 may permit data to be exchanged with a network and/or any other devices or systems described in the present disclosure.

Modifications, additions, or omissions may be made to the computing system 1500 without departing from the scope of the present disclosure. For example, in some embodiments, the computing system 1500 may include any number of other components that may not be explicitly illustrated or described.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

Embodiments described in the present disclosure may be implemented using computer-readable media for carrying or having computer-executable instructions or data structures stored thereon. Such computer-readable media may be any available media that may be accessed by a general-purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

What is claimed is:

1. An objective lens comprising:
one or more lenses;
an outer housing configured to encompass at least the one or more lenses; and
a mask to shape a point spread function (PSF) of the objective lens to define an engineered PSF (ePSF) of the objective lens.

2. The objective lens of claim 1, wherein the objective lens is designed for computational imaging.

3. The objective lens of claim 1, wherein the mask is configured to modulate at least one of phase, amplitude, or polarization.

4. The objective lens of claim 1, wherein the mask is implemented by at least one of a diffractive optic, a refractive optic, a holographic optic, a metasurface optic, an aspheric optic, a free-form optic, a spatial light modulator, a deformable lens, or a prism array.

5. The objective lens of claim 1, wherein the mask is positioned in an exit pupil of the objective lens.

6. The objective lens of claim 5, wherein the exit pupil is positioned near or external to a back aperture of the objective lens.

7. The objective lens of claim 1, wherein the mask is implemented in an optical element positioned external to the objective lens, the optical element retained at a fixed location relative to the objective lens.

8. The objective lens of claim 1, wherein the mask is positioned in a pupil plane, an image plane, or other location of the objective lens.

9. The objective lens of claim 1, wherein the mask is positioned within the outer housing, the one or more lenses include a first lens and a second lens, and the mask is positioned between the first and second lenses within the outer housing.

10. The objective lens of claim 1, wherein the mask is attached to or formed in or on one or more surfaces of the one or more lenses.

11. The objective lens of claim 1, wherein the mask is implemented in an optical element that includes at least one of an extended depth of field mask, a cubic phase mask, a double helix point spread function mask, a diffractive optical element, a grating, a Dammann grating, a diffuser, a phase mask, a hologram, an amplitude mask, a spatial light modulator, or a prism array.

12. The objective lens of claim 1, wherein at least one of:
a maximum of the ePSF describes one or more curves in 3D space;
at least one of the mask or at least one of the one or more lenses operates in reflection mode;
the mask is designed to optimize the ePSF for 2D imaging;
the mask is designed to optimize the ePSF for 3D imaging; or
the mask generates a set of at least two spots located in 3D space.

13. The objective lens of claim 1, wherein the mask is designed to correct for, or optimize for, one or more optical aberrations in one or more of an image plane or a defocus plane.

14. A computational imaging system, comprising:
a light source;
an optical system configured to illuminate a scene or a sample with light from the light source and to direct light from the scene or the sample to a detector;
an objective lens included in the optical system, the objective lens including a mask to shape a three-dimensional (3D) point spread function (PSF) of the optical system to define an engineered PSF (ePSF) of the optical system;
the detector configured to receive light from the scene or the sample after it passes through the objective lens and to generate an image from the received light; and
a computing device communicatively coupled to the light detector, the computing device configured to estimate properties of one or more objects within the scene or the sample from the image.

15. The computational imaging system of claim 14, wherein the properties include at least one of detection of objects within the scene or the sample, a number of objects within the scene or the sample, a classification of objects within the scene or the sample, a 2D or 3D localization of objects within the scene or the sample, or 2D or 3D tracking of objects within the scene or the sample.

16. The computational imaging system of claim 14, wherein:
the computing device is configured to estimate properties of the one or more objects using one or more estimation processes; and
the objective lens and the estimation processes are jointly designed and optimized.

17. The computational imaging system of claim 14, wherein the objective lens is configured to modulate at least one of phase, amplitude, or polarization to shape the PSF.

18. The computational imaging system of claim 14, wherein the mask is implemented by at least one of a diffractive optic, a refractive optic, a hologram, a metasurface optic, an aspheric optic, a free-form optic, a spatial light modulator, a deformable lens, or a prism array.

19. The computational imaging system of claim 14, wherein the mask is implemented in an optical element that includes at least one of an extended depth of field mask, a cubic phase mask, a double helix point spread function mask, a diffractive optical element, a grating, a Dammann grating, a diffuser, a phase mask, a hologram, an amplitude mask, a spatial light modulator, or a prism array.

20. The computational imaging system of claim 14, wherein the light received from the scene or the sample is the result of one or more of the following: scattering, transmission, reflection, luminescence, absorption, polarization, phase shift, fluorescence, two or multi-photon fluorescence, high harmonic generation, refraction, and/or diffraction at or from the one or more objects within the scene or the sample.

21. The computational imaging system of claim 14, wherein the optical system comprises an infinity-corrected optical system.

22. The computational imaging system of claim 14, wherein the optical system comprises a finite-correction optical system.

23. The computational imaging system of claim 14, wherein the detector comprises a camera, a single-photon avalanche diode (SPAD) array, a complementary metal-oxide-semiconductor (CMOS) active-pixel sensor (APS), or a charge-coupled device (CCD) image sensor.

24. A method comprising:
directing light from a scene through an optical system that includes an objective lens containing a mask to shape a point spread function (PSF) of the optical system;
generating, using a detector, an image of the scene from the light that passes through the optical system; and
estimating a property of one or more objects within the scene from the image of the scene.

25. The method of claim 24, wherein the property includes at least one of detection of objects within the scene, a number of objects within the scene, a classification of objects within the scene, a 2D or 3D localization of objects within the scene, or 2D or 3D tracking of objects within the scene.

26. The method of claim 24, wherein the light from the scene is the result of one or more of scattering, transmission, reflectance, luminescence, scattering, absorption, polarization, phase shift, fluorescence, two or multi-photon fluorescence, high harmonic generation, refraction, and diffraction at or from the one or more objects within the scene.

27. The method of claim 24, further comprising computationally recovering the image.

28. The method of claim 27, wherein:
the method further comprises determining the PSF of the optical system; and
computationally recovering the image comprises:
padding the image of the scene on all sides according to a size of its Optical Transfer Function (OTF) to make a deconvolution of the image of the sample of interest non-circulant;
deconvolving the padded image using the OTF to restore spatial organization of energy in the image; and
trimming off extra pixels padded on the sides of the image for deconvolution processing.
